(19) United States
(12) Patent Application Publication
(10) Pub. No.: US 2025/0349038 A1
(43) Pub. Date: Nov. 13, 2025

(54) METHOD OF ENCODING POINT CLOUD DATA, METHOD OF DECODING POINT CLOUD DATA, POINT CLOUD DECODER

(71) Applicant: GUANGDONG OPPO MOBILE TELECOMMUNICATIONS CORP., LTD., Dongguan, Guangdong (CN)

(72) Inventors: Yue YU, Palo Alto, CA (US); Haoping YU, Palo Alto, CA (US)

(21) Appl. No.: 18/872,242

(22) PCT Filed: Jun. 14, 2023
(86) PCT No.: PCT/US2023/025309

§ 371 Date: Dec. 5, 2024

Related U.S. Application Data
(60) Provisional application No. 63/366,446, filed on Jun. 15, 2022.

(51) Int. Cl. G06T 9/00; H04N 19/152; H04N 19/18; H04N 19/70

(52) U.S. Cl. CPC G06T 9/001; H04N 19/152; H04N 19/18; H04N 19/70

(57) ABSTRACT

A method of encoding point cloud data, a method of decoding point cloud data, and a point cloud decoder are disclosed. The method of decoding point cloud data includes decoding a geometry information of a point cloud data and decoding an attribute information of the point cloud data based on the geometry information, wherein a first parameter associated with the attribute information is decoded with a Logarithmic format plus a fixed integer, or at least one value associated with the attribute information is specified.

### CROSS-REFERENCE TO RELATED APPLICATIONS

This application is National Stage of International Application No. PCT/US2023/025309, filed Jun. 14, 2023, which claims priority to U.S. Provisional Application No. 63/366,446, filed on Jun. 15, 2022, which are hereby incorporated in their entirety by this reference.

### TECHNICAL FIELD

The present disclosure relates to the field of augmented reality (AR) and/or video technologies, and more particularly, to a method of encoding point cloud data, a method of decoding point cloud data, and a point cloud decoder, which can provide at least one improvement for point cloud coding (PCC) such as geometry point cloud coding (G-PCC).

### BACKGROUND

A point cloud is a collection of points in a 3-dimensional space. The points may correspond to points on objects within the 3-dimensional space. Thus, a point cloud may be used to represent the physical content of the 3-dimensional space. Point clouds may have utility in a wide variety of situations. For example, point clouds may be used in the context of autonomous vehicles for representing the positions of objects on a roadway. In another example, point clouds may be used in the context of representing the physical content of an environment for purposes of positioning virtual objects in an augmented reality (AR) or mixed reality (MR) application. Point cloud compression is a process for coding (including encoding and/or decoding) point clouds. Encoding point clouds may reduce the amount of data required for storage and transmission of point clouds.

The current point cloud coding such as a current geometry point cloud coding (G-PCC) cannot work well for a wide range of PCC input. Therefore, there is a need for methods, systems, and apparatuses for point cloud coding, which can work well for a wide range of PCC input and/or can be used in many applications.

### SUMMARY

In a first aspect of the present disclosure, a method of encoding point cloud data includes encoding a geometry information of a point cloud data and encoding an attribute information of the point cloud data based on the geometry information, wherein a first parameter associated with the attribute information is encoded with a Logarithmic format minus a fixed integer, or at least one value associated with the attribute information is specified.

In a second aspect of the present disclosure, a method of decoding point cloud data includes decoding a geometry information of a point cloud data and decoding an attribute information of the point cloud data based on the geometry information, wherein a first parameter associated with the attribute information is decoded with a Logarithmic format plus a fixed integer, or at least one value associated with the attribute information is specified.

In a third aspect of the present disclosure, a point cloud decoder includes a decoder configured to decode a geometry information of a point cloud data and decode an attribute information of the point cloud data based on the geometry information, wherein a first parameter associated with the attribute information is decoded with a Logarithmic format plus a fixed integer, or at least one value associated with the attribute information is specified.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic structural diagram of a geometry point cloud coding (G-PCC) system.

FIG. 2 is a schematic structural diagram of a G-PCC encoder.

FIG. 3 is a schematic structural diagram of a G-PCC decoder.

FIG. 4 is a schematic structural diagram of octree structure of G-PCC and corresponding digital representation.

FIG. 5 is a schematic structural diagram of a structure of cube and relationship with neighboring cubes.

FIG. 6 is a block diagram illustrating an example of a point cloud coder according to an embodiment of the present application.

FIG. 7 is a block diagram illustrating an example of a coding device according to an embodiment of the present application.

FIG. 8 is a block diagram illustrating an example of a method of coding point cloud data according to an embodiment of the present application.

FIG. 9 is a block diagram of an example of a point cloud encoder according to an embodiment of the present disclosure.

FIG. 10 is a block diagram of an example of an encoding device according to an embodiment of the present disclosure.

FIG. 11 is a block diagram of an example of a method of encoding point cloud data according to an embodiment of the present disclosure.

FIG. 12 is a block diagram of an example of a point cloud decoder according to an embodiment of the present disclosure.

FIG. 13 is a block diagram of an example of a decoding device according to an embodiment of the present disclosure.

FIG. 14 is a block diagram of an example of a method of decoding point cloud data according to an embodiment of the present disclosure.

FIG. 15 is a block diagram of an example of a computing device according to an embodiment of the present disclosure.

FIG. 16 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In some embodiments of the disclosure, coding refers to encoding and/or decoding, and more particularly, to encoding and/or decoding methods, systems, or apparatuses.

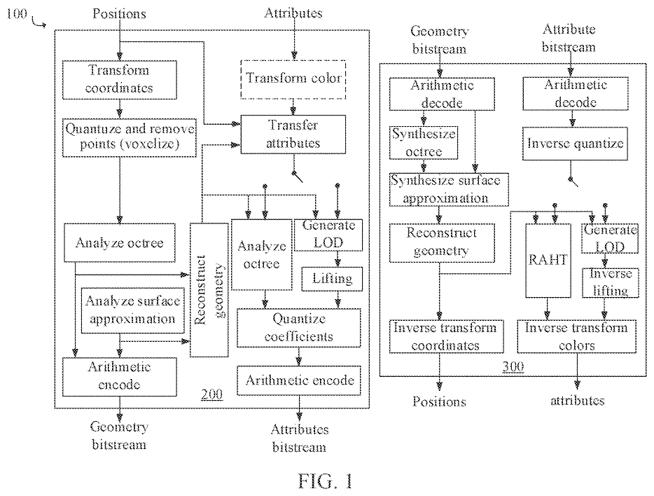

Geometry point cloud coding (G-PCC) is widely used in virtual reality/augmented reality/mixed reality (VR/AR/MR) for entertainment and industrial applications, e.g., light detection and ranging (LiDAR) sweep compression for automotive or robotics and high definition (HD) map for navigation. Moving picture experts group (MPEG) has released the first version G-PCC standard and audio video coding standard (AVS) is also developing a G-PCC standard. In order to compress point cloud data efficiently, a geometry of a point cloud is compressed first, and corresponding attributes including color and/or reflectance, etc., are compressed based upon geometry information. A geometry point cloud coding (G-PCC) system 100 including a G-PCC encoder 200 and/or a G-PCC decoder 300 is illustrated in FIG. 1.

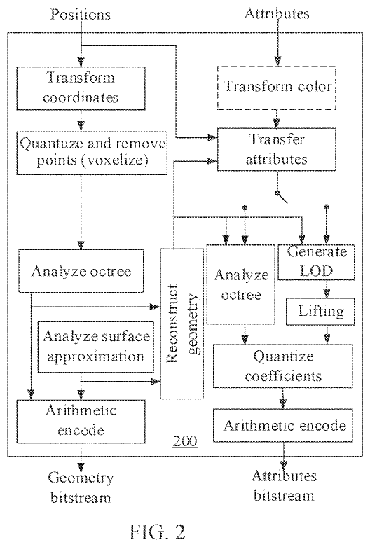

FIG. 1 provides an overview of the G-PCC system 100 including the G-PCC encoder 200 and/or the G-PCC decoder 300. The G-PCC system 100 is configured to implement some embodiments of the disclosure. FIG. 2 provides the G-PCC encoder 200. The G-PCC encoder 200 is configured to implement some embodiments of the disclosure. FIG. 3 provides the G-PCC decoder 300. The G-PCC decoder 300 is configured to implement some embodiments of the disclosure. Modules illustrated in FIG. 1, FIG. 2, and FIG. 3 are logical. Some embodiments of the disclosure may be implemented into the G-PCC system 100, the G-PCC encoder 200, and/or the G-PCC decoder 300 using any suitably configured hardware and/or software. In both the G-PCC encoder 200 and G-PCC decoder 300, point cloud positions are coded first. Attribute coding depends on the decoded geometry. At least one module such as analyze surface approximation and/or RAHT (region adaptive hierarchical transform) of the G-PCC encoder as illustrated in FIG. 1 and FIG. 2 and/or synthesize surface approximation and/or RAHT of the G-PCC decoder as illustrated in FIG. 1 and FIG. 3 is an option used for Category 1 data. At least one module such as generate LOD (level of detail) and/or lifting of the G-PCC encoder as illustrated in FIG. 1 and FIG. 2 and/or generate LOD and/or inverse lifting of the G-PCC decoder as illustrated in FIG. 1 and FIG. 3 is an option used for Category 3 data. All the other modules are common between Categories 1 and 3.

For Category 3 data, the compressed geometry may be represented as an octree from the root all the way down to a leaf level of individual voxels. For Category 1 data, the compressed geometry may be represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

There are 3 attribute coding methods in G-PCC: Region adaptive hierarchical transform (RAHT) coding, interpolation-based hierarchical nearest-neighbor prediction (predicting transform), and interpolation-based hierarchical nearest-neighbor prediction with an update/lifting step (lifting transform). RAHT and lifting are used for Category 1 data, while predicting is used for Category 3 data. However, either method may be used for any data, and just like with the geometry codecs in G-PCC, the user has the option to choose which of the 3 attribute codecs they would like to use.

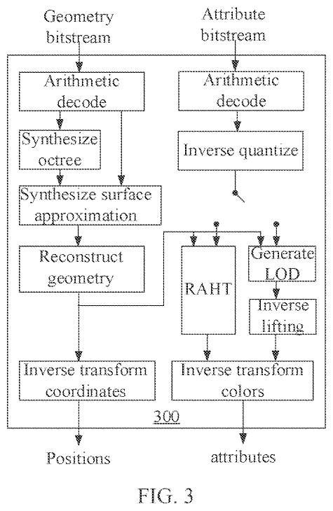

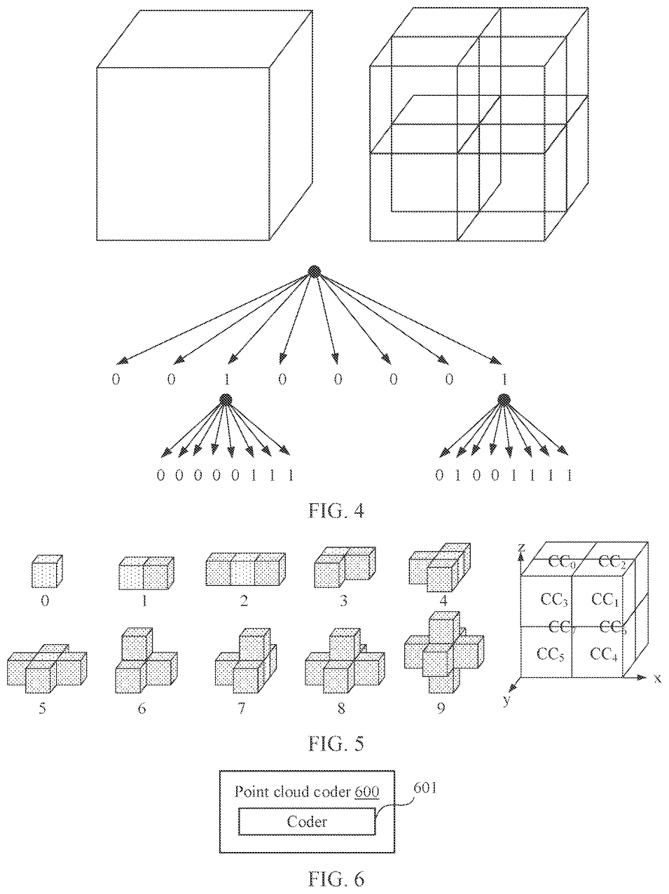

A cubical axis-aligned bounding box is defined by the two extreme points (0,0,0) and (2^{d}, 2^{d}, 2^{d}) where d is the maximum size of the given point cloud along x, y or z direction. A point of point cloud may be noted as point illustrated in FIG. 4. All points are included in this defined cube. A cube is divided into eight sub-cubes, which creates the octree structure allowing one parent cube to have 8 child cubes. The 7 sibling cubes of a given cube are the same size cubes and share at least one same face/edge/point with this given cube. The volume of a cube is ⅛ volume of its parent cube. A cube may contain more than one point and the number of points in a cube is dependent on the size and location of the cube. The size of a smallest cube is pre-defined for a given point cloud. As one example, a minimum cube can be defined. For a given point, the parent cube of a given point is defined as a minimum size cube which contains this given point. Sibling points of a given point are defined as those points which have the same parent cube with this given point.

FIG. 4 demonstrates an octree structure of G-PCC and the corresponding digital representation. An octree is a recursive data structure that may be used to describe three-dimensional space in which each internal cube has exactly eight children. The space is recursively subdivided into eight octants to the point where the resolution of the child cube is equal to a size of the point—the smallest element that has no further subdivisions. To represent a cube an 8-bit binary code that follows a space-filling curve pattern (Hilbert, Morton) is used, each child is assigned a “1” or “0” value to indicate if the space in the child cube has any points associated with that child cube, or the child cube is empty. Only the occupied child cubes are further subdivided. The process of parent cube subdivision is terminated when the size of the child cube becomes equal to the size of the indivisible element, i.e., spatial resolution of the point cloud, or simply the size of the point.

FIG. 5 illustrates a structure of cube and relationship with neighboring cubes. Depending on the location of the current cube, one cube may have up to six same-size cubes to share one face, as illustrated in FIG. 5. In addition, the current cube may also have some neighboring cubes which share lines or point with the current cube. Similarly, the parent cube of the current cube also has up to six neighboring cubes with the same size of the parent cube that share one face with the parent cube. The parent cube of the current cube also has up to twelve neighboring cubes with the same size of parent cubes that share an edge. The parent cube of the current cube also has up to eight neighboring cubes with the same size of parent cubes that share a point with the parent cube.

The octree-based geometry information may be coded with context-based arithmetic coding. There may also be some corresponding attribute information for point clouds, including color, reflectance, etc., that needs to be compressed. Because the neighboring points in a point cloud may have a strong correlation, prediction-based coding methods have been developed and used to compose and code point cloud attributes. More specifically, a prediction is formed from neighboring coded attributes. Further, the difference between the current attribute and the prediction is coded.

Some embodiments of the disclosure propose methods, systems, and apparatuses for point cloud coding, which can provide at least one improvement for point cloud coding (PCC) such as geometry point cloud coding (G-PCC), can work well for a wide range of PCC input, and/or can be used in many applications. The at least one proposed solution, method, system, and apparatus of some embodiments of the present disclosure may be used for current and/or new/future G-PCC coding standards, especially for audio video coding standard (AVS) GPCC (GPCC refers to G-PCC). Compatible products follow at least one proposed solution, method, system, and apparatus of some embodiments of the present disclosure. The proposed solution, method, system, and apparatus are widely used in the G-PCC related products. With the implementation of the at least one proposed solution, method, system, and apparatus of some embodiments of the present disclosure, at least one modification to bitstream structure, syntax, constraints, and mapping for the generation of decoded point cloud are considered for standardizing.

### Technical Solution

### Solution 1

One parameter, maxNumofCoeff is added and specified in the current AVS GPCC to control the maximum buffer size to hold number of transform coefficients. In addition, another parameter, coeffLengthControl is specified to allow the maximum delay which is defined as maxNumofCoeff*coeffLengthControl. Both parameters are coded with ue(v) which is 0-order exponential Golomb (EG) coding specified in the following Table 1 to code the given integer v. x0, x1 . . . , xn are binary numbers.

TABLE 1
k-order EG

| | | The value |
|---|---|---|
| Order | Code word | represented |
| k = 0 | 1 | 0 |
| | 0 1 x₀ | 1~2 |
| | 0 0 1 x₁ x₀ | 3~6 |
| | 0 0 0 1 x₂ x₁ x₀ | 7~14 |
| | . . . | . . . |
| k = 1 | 1 x₀ | 0~1 |
| | 0 1 x₁ x₀ | 2~5 |
| | 0 0 1 x₂ x₁ x₀ | 6~13 |
| | 0 0 0 1 x₃ x₂ x₁ x₀ | 14~29 |
| | . . . | . . . |
| k = 2 | 1 x₁ x₀ | 0~3 |
| | 0 1 x₂ x₁ x₀ | 4~11 |
| | 0 0 1 x₃ x₂ x₁ x₀ | 12~27 |
| | 0 0 0 1 x₄ x₃ x₂ x₁ x₀ | 28~59 |
| | . . . | . . . |
| k = 3 | 1 x₂ x₁ x₀ | 0~7 |
| | 0 1 x₃ x₂ x₁ x₀ | 8~23 |
| | 0 0 1 x₄ x₃ x₂ x₁ x₀ | 24~55 |
| | 0 0 0 1 x₅ x₄ x₃ x₂ x₁ x₀ | 56~119 |
| | . . . | . . . |

It is understood that maxNumofCoeff is an integer number of power of 2. Some embodiments of the disclosure propose to code (encode/decode) this parameter with a Logarithmic format instead of directly coding its decimal value. For example, this parameter is coded with a Logarithmic format minus or plus a fixed integer. For example, this parameter is encoded with a Logarithmic format minus a fixed integer. For example, this parameter is decoded with a Logarithmic format plus a fixed integer. For example, at encoder side, suppose some embodiments want to code 256 and some embodiments use log 2(X)minusY. Suppose Y is 8, some embodiments may get log 2(256)−8=0. Therefore, “0” may be coded in the bitstream instead of “256” at encoder side. In the decoder side, “0” is decoded first and then some embodiments recover the value=1<<(0+8)=256.

More specifically, log 2 maxNumofCoeffMinusX is coded in the bitstream with ue(v) format, where X is an integer number. For example, X is 10, and log 2maxNumofCoeffMinus10 may be coded (encoded/decoded). The maxNumofCoeff could be calculated as follows: maxNumofCoeff=1<<(log 2maxNumofCoeffMinus10+10).

The possible syntax change could be as follows.

| | |
|---|---|
| If (transform && | |
| (attributePresentFlag[0] ∥ attributePresentFlag[1])) { | |
| log2maxNumofCoeffMinus10 | ue(v) |
| coeffLengthControl | ue(v) |

The corresponding semantics for log 2maxNumofCoeffMinus10 is as follows.

log 2maxNumofCoeffMinus10 is an unsigned integer number between 0 and 16 that specifies maxNumofCoeff as the maximum buffer size to hold the number of transform coefficients. maxNumofCoeff is calculated as follows: maxNumofCoeff=1<<(log 2maxNumofCoeffMinus10+10).

More specifically, log 2 maxNumofCoeffMinusX is coded in the bitstream with ue(v) format, where X is an integer number. For example, X is 8, and log 2maxNumofCoeffMinus8 may be coded (encoded/decoded). The maxNumofCoeff could be calculated as follows: maxNumofCoeff=1<<(log 2maxNumofCoeffMinus8+8).

The possible syntax change could be as follows.

| | |
|---|---|
| If (transform && | |
| (attributePresentFlag[0] ∥ attributePresentFlag[1])) { | |
| log2maxNumofCoeffMinus8 | ue(v) |
| coeffLengthControl | ue(v) |

The corresponding semantics for log 2maxNumofCoeffMinus8 is as follows.

log 2maxNumofCoeffMinus8 is an unsigned integer number between 0 and 16 that specifies maxNumofCoeff as the maximum buffer size to hold the number of transform coefficients. maxNumofCoeff is calculated as follows: maxNumofCoeff=1<<(log 2maxNumofCoeffMinus8+8).

### Solution 2

In the current AVS-GPCC specification, two parameters, colorGolumbNum and RefGolombNum are used to specify the order of EG for coding color and reflectance attributes, respectively. Both parameters are coded with ue(v). Some embodiments of the disclosure propose that the allowed value for both attributes could not be larger than a specified number, e.g., N, so that the codec has a reasonable implementation complexity. More specifically, both colorGolumbNum and RefGolombNum are coded with ue(v), and they are specified as being not larger than 8 in the AVS-GPCC specification.

### Solution 3

In the current AVS-GPCC, the attribute residual is first binarized in a format with a zero-run-length plus a non-zero residual value and further coded using context-based adaptive binary arithmetic coding (CABAC). Some embodiments of the disclosure propose that the value of zero-run-length could be specified and constrained to smaller than a predefined number so that it is friendly for hardware implementations.

More specifically, the value of zero-run-length could be coded as follows. The first bin is coded to indicate if the value of zero-run-length is zero or not. If the value of zero-run-length is not zero, the second bin is coded to indicate if the value of zero-run-length is one or not. If the value of zero-run-length is not one, the third bin is coded to indicate if the value of zero-run-length is two or not. If the value of zero-run-length is not two, a parity flag may be coded to indicate if the value of zero-run-length is an odd or even number. After these four flags, a remainder that represents the value of (zero-run-length−2)/2 may be coded. This remainder may be coded with a specified colorGolumbNum or RefGolombNum-order EG or unary code.

Some examples assume that this remainder is coded with a 2nd-order EG code. If the maximum number of bins, either coded with context coded or bypass method the hardware can support is N, the maximum value for a 2nd-order EG code could be 1<<((N−1)>>2+2)−4. For example, if N is 32, the maximum value for the remainder could be 1<<((32−1)>>2+2)−4, which is equal to 131068. Because the value of zero-run-length is coded with a parity value, the maximum value represented could be 262138, which is 131068*2+2. Therefore, some embodiments of the disclosure propose that the maximum value of zero run length is set as 262138 for AVS-GPCC.

Alternatively, the allowed maximum value of zero-run-length could be set as any value smaller than 262138. For example, the maximum value could be set as a fixed number or coded in the bitstream, either in the SPS or an attribute header. For example, the allowed maximum value of the zero-run-length could be set as 131072.

FIG. 6 illustrates an example of a point cloud coder 600 according to an embodiment of the present application. The point cloud coder 600 is configured to implement some embodiments of the disclosure. Some embodiments of the disclosure may be implemented into the point cloud coder 600 using any suitably configured hardware and/or software. The point cloud coder 600 includes a coder 601 configured to code a geometry information of a point cloud data and code an attribute information of the point cloud data based on the geometry information, wherein a first parameter associated with the attribute information is coded with a Logarithmic format minus or plus a fixed integer, or at least one value associated with the attribute information is specified. This can provide at least one improvement for point cloud coding (PCC) such as geometry point cloud coding (G-PCC), can work well for a wide range of PCC input, and/or can be used in many applications.

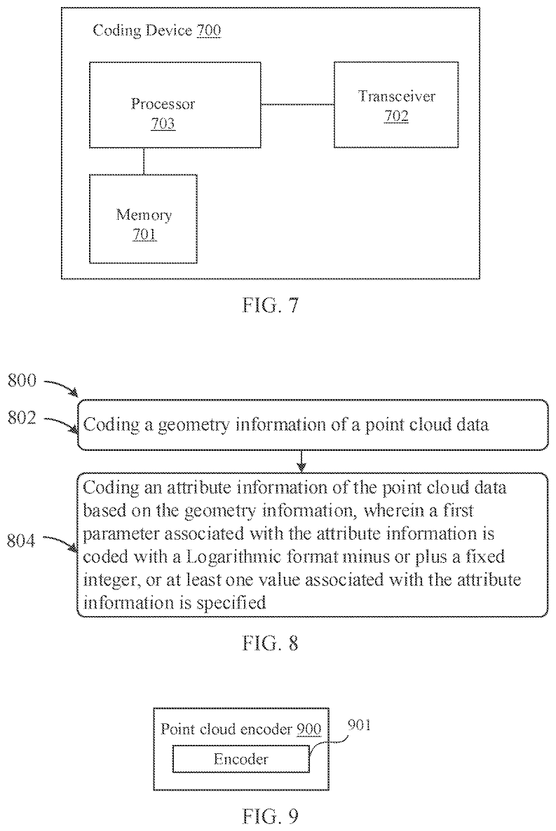

FIG. 7 illustrates an example of a coding device 700 according to an embodiment of the present disclosure. The coding device 700 is configured to implement some embodiments of the disclosure. Some embodiments of the disclosure may be implemented into the coding device 700 using any suitably configured hardware and/or software. The coding device 700 may include a memory 701, a transceiver 702, and a processor 703 coupled to the memory 701 and the transceiver 702. The processor 703 may be configured to implement proposed functions, procedures and/or methods described in this description. Layers of radio interface protocol may be implemented in the processor 703. The memory 701 is operatively coupled with the processor 703 and stores a variety of information to operate the processor 703. The transceiver 702 is operatively coupled with the processor 703, and the transceiver 702 transmits and/or receives a radio signal. The processor 703 may include application-specific integrated circuit (ASIC), other chipset, logic circuit and/or data processing device. The memory 701 may include read-only memory (ROM), random access memory (RAM), flash memory, memory card, storage medium and/or other storage device. The transceiver 702 may include baseband circuitry to process radio frequency signals. When the embodiments are implemented in software, the techniques described herein can be implemented with modules (e.g., procedures, functions, and so on) that perform the functions described herein. The modules can be stored in the memory 701 and executed by the processor 703. The memory 701 can be implemented within the processor 703 or external to the processor 703 in which case those can be communicatively coupled to the processor 703 via various means as is known in the art.

In some embodiments, the processor 703 configured to code a geometry information of a point cloud data and code an attribute information of the point cloud data based on the geometry information, wherein a first parameter associated with the attribute information is coded with a Logarithmic format minus or plus a fixed integer, or at least one value associated with the attribute information is specified. This can provide at least one improvement for point cloud coding (PCC) such as geometry point cloud coding (G-PCC), can work well for a wide range of PCC input, and/or can be used in many applications.

FIG. 8 is an example of a method 800 of coding point cloud data according to an embodiment of the present disclosure. The method 800 of coding point cloud data is configured to implement some embodiments of the disclosure. Some embodiments of the disclosure may be implemented into the method 800 of coding point cloud data using any suitably configured hardware and/or software. In some embodiments, the method 800 of coding point cloud data includes: an operation 802, coding a geometry information of a point cloud data, and an operation 804, coding an attribute information of the point cloud data based on the geometry information, wherein a first parameter associated with the attribute information is coded with a Logarithmic format minus or plus a fixed integer, or at least one value associated with the attribute information is specified. This can provide at least one improvement for point cloud coding (PCC) such as geometry point cloud coding (G-PCC), can work well for a wide range of PCC input, and/or can be used in many applications.

In some embodiments, the first parameter includes maxNumofCoeff used to control a maximum buffer size to hold a number of transform coefficients. In some embodiments, log 2maxNumofCoeffMinusX is coded in a bitstream with a ue(v) format, where X is an integer number, and the ue(v) forma is 0-order exponential Golomb (EG) coding. In some embodiments, X is equal to 8, the log 2maxNumofCoeffMinus8 is coded, and the log 2maxNumofCoeffMinus8 is an unsigned integer number between 0 and 16 used to specify the maxNumofCoeff as the maximum buffer size to hold the number of transform coefficients. In some embodiments, maxNumofCoeff is calculated as follows: maxNumofCoeff=1<<(log 2maxNumofCoeffMinus8+8).

In some embodiments, the at least one value associated with the attribute information includes an allowed value of a second parameter and/or a third parameter associated with the attribute information, and the allowed value is not larger than a specified number. In some embodiments, the second parameter includes colorGolumbNum used to specify an order of EG for coding a color attribute. In some embodiments, the third parameter includes RefGolombNum used to specify an order of EG for coding a reflectance attribute. In some embodiments, the specified number is equal to 8.

In some embodiments, the at least one value associated with the attribute information includes a value of a zero-run-length, and the value of the zero-run-length is smaller than a predefined number. In some embodiments, if an order of EG used for coding the attribute information is smaller than a predefined value, a first bin is coded to indicate if the value of the zero-run-length is zero or not. In some embodiments, if the value of the zero-run-length is not zero, a second bin is coded to indicate if the value of the zero-run-length is one or not. In some embodiments, if the value of the zero-run-length is not one, a third bin is coded to indicate if the value of the zero-run-length is two or not. In some embodiments, if the value of the zero-run-length is not two, a parity flag is coded to indicate if the value of the zero-run-length is an odd or even number.

In some embodiments, a remainder representing the value of (zero-run-length−2)/2 is coded. In some embodiments, the remainder is coded with a specified order EG or unary code. In some embodiments, the specified order EG may be a 2nd order EG. In some embodiments, if a maximum number of bins is N, a maximum value for the 2nd-order EG code is 1<<((N−1)>>2+2)−4, where N is an integer number. In some embodiments, if N is equal to 32, the maximum value for the remainder is 1<<((32−1)>>2+2)−4, which is equal to 131068. In some embodiments, the value of the zero-run-length is coded with a parity value, a maximum value of the zero-run-length is 262138, which is 131068*2+2. In some embodiments, an allowed maximum value of the zero-run-length is set as a value smaller than 262138. In some embodiments, the allowed maximum value of the zero-run-length is set as a fixed number or coded in a bitstream. In some embodiments, the allowed maximum value of the zero-run-length is set as 131072.

FIG. 9 illustrates an example of a point cloud encoder 900 according to an embodiment of the present application. The point cloud encoder 900 is configured to implement some embodiments of the disclosure. Some embodiments of the disclosure may be implemented into the point cloud encoder 900 using any suitably configured hardware and/or software. The point cloud encoder 900 includes a encoder 901 configured to encode a geometry information of a point cloud data and encode an attribute information of the point cloud data based on the geometry information, wherein a first parameter associated with the attribute information is encoded with a Logarithmic format minus a fixed integer, or at least one value associated with the attribute information is specified. This can provide at least one improvement for point cloud encoding such as geometry point cloud encoding, can work well for a wide range of point cloud encoding input, and/or can be used in many applications.

FIG. 10 illustrates an example of an encoding device 1000 according to an embodiment of the present disclosure. The encoding device 1000 is configured to implement some embodiments of the disclosure. Some embodiments of the disclosure may be implemented into the encoding device 1000 using any suitably configured hardware and/or software. The encoding device 1000 may include a memory 1001, a transceiver 1002, and a processor 1003 coupled to the memory 1001 and the transceiver 1002. The processor 1003 may be configured to implement proposed functions, procedures and/or methods described in this description. Layers of radio interface protocol may be implemented in the processor 1003. The memory 1001 is operatively coupled with the processor 1003 and stores a variety of information to operate the processor 1003. The transceiver 1002 is operatively coupled with the processor 1003, and the transceiver 1002 transmits and/or receives a radio signal. The processor 1003 may include application-specific integrated circuit (ASIC), other chipset, logic circuit and/or data processing device. The memory 1001 may include read-only memory (ROM), random access memory (RAM), flash memory, memory card, storage medium and/or other storage device. The transceiver 1002 may include baseband circuitry to process radio frequency signals. When the embodiments are implemented in software, the techniques described herein can be implemented with modules (e.g., procedures, functions, and so on) that perform the functions described herein. The modules can be stored in the memory 1001 and executed by the processor 1003. The memory 1001 can be implemented within the processor 1003 or external to the processor 1003 in which case those can be communicatively coupled to the processor 1003 via various means as is known in the art.

In some embodiments, the processor 1003 configured to encode a geometry information of a point cloud data and encode an attribute information of the point cloud data based on the geometry information, wherein a first parameter associated with the attribute information is encoded with a Logarithmic format minus a fixed integer, or at least one value associated with the attribute information is specified. This can provide at least one improvement for point cloud encoding such as geometry point cloud encoding, can work well for a wide range of point cloud encoding input, and/or can be used in many applications.

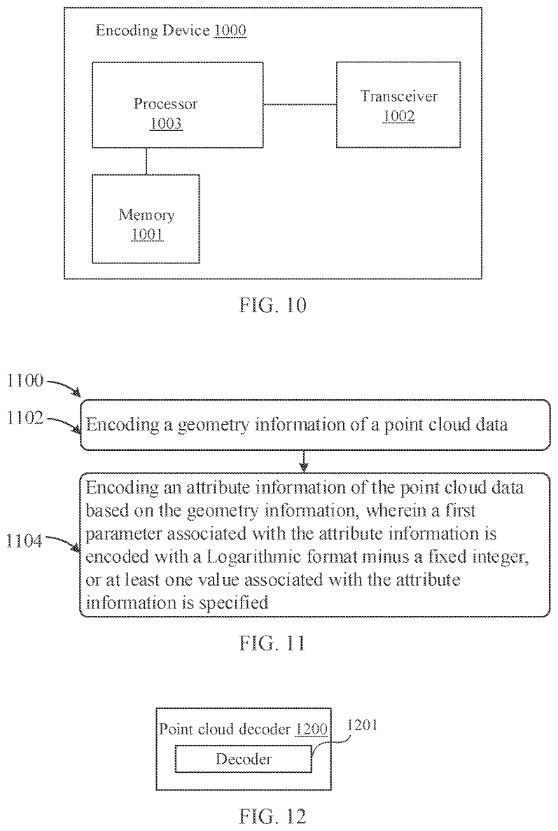

FIG. 11 is an example of a method 1100 of encoding point cloud data according to an embodiment of the present disclosure. The method 1100 of encoding point cloud data is configured to implement some embodiments of the disclosure. Some embodiments of the disclosure may be implemented into the method 1100 of encoding point cloud data using any suitably configured hardware and/or software. In some embodiments, the method 1100 of encoding point cloud data includes: an operation 1102, encoding a geometry information of a point cloud data, and an operation 1104, encoding an attribute information of the point cloud data based on the geometry information, wherein a first parameter associated with the attribute information is encoded with a Logarithmic format minus a fixed integer, or at least one value associated with the attribute information is specified. This can provide at least one improvement for point cloud encoding such as geometry point cloud encoding, can work well for a wide range of point cloud encoding input, and/or can be used in many applications.

In some embodiments, the first parameter includes maxNumofCoeff used to control a maximum buffer size to hold a number of transform coefficients. In some embodiments, log 2 maxNumofCoeffMinusX is encoded in a bitstream with a ue(v) format, where X is an integer number, and the ue(v) forma is 0-order exponential Golomb (EG) encoding. In some embodiments, X is equal to 8, the log 2maxNumofCoeffMinus8 is encoded, and the log 2maxNumofCoeffMinus8 is an unsigned integer number between 0 and 16 used to specify the maxNumofCoeff as the maximum buffer size to hold the number of transform coefficients. In some embodiments, maxNumofCoeff is calculated as follows: maxNumofCoeff=1<<(log 2maxNumofCoeffMinus8+8).

In some embodiments, the at least one value associated with the attribute information includes an allowed value of a second parameter and/or a third parameter associated with the attribute information, and the allowed value is not larger than a specified number. In some embodiments, the second parameter includes colorGolumbNum used to specify an order of EG for encoding a color attribute. In some embodiments, the third parameter includes RefGolombNum used to specify an order of EG for encoding a reflectance attribute. In some embodiments, the specified number is equal to 8.

In some embodiments, the at least one value associated with the attribute information includes a value of a zero-run-length, and the value of the zero-run-length is smaller than a predefined number. In some embodiments, if an order of EG used for encoding the attribute information is smaller than a predefined value, a first bin is encoded to indicate if the value of the zero-run-length is zero or not. In some embodiments, if the value of the zero-run-length is not zero, a second bin is encoded to indicate if the value of the zero-run-length is one or not. In some embodiments, if the value of the zero-run-length is not one, a third bin is encoded to indicate if the value of the zero-run-length is two or not. In some embodiments, if the value of the zero-run-length is not two, a parity flag is encoded to indicate if the value of the zero-run-length is an odd or even number.

In some embodiments, a remainder representing the value of (zero-run-length−2)/2 is encoded. In some embodiments, the remainder is encoded with a specified order EG or unary encode. In some embodiments, the specified order EG may be a 2nd order EG. In some embodiments, if a maximum number of bins is N, a maximum value for the 2nd-order EG encode is 1<<((N−1)>>2+2)−4, where N is an integer number. In some embodiments, if N is equal to 32, the maximum value for the remainder is 1<<((32−1)>>2+2)−4, which is equal to 131068. In some embodiments, the value of the zero-run-length is encoded with a parity value, a maximum value of the zero-run-length is 262138, which is 131068*2+2. In some embodiments, an allowed maximum value of the zero-run-length is set as a value smaller than 262138. In some embodiments, the allowed maximum value of the zero-run-length is set as a fixed number or encoded in a bitstream. In some embodiments, the allowed maximum value of the zero-run-length is set as 131072.

FIG. 12 illustrates an example of a point cloud decoder 1200 according to an embodiment of the present application. The point cloud decoder 1200 is configured to implement some embodiments of the disclosure. Some embodiments of the disclosure may be implemented into the point cloud decoder 1200 using any suitably configured hardware and/or software. The point cloud decoder 1200 includes a decoder 1201 configured to decode a geometry information of a point cloud data and decode an attribute information of the point cloud data based on the geometry information, wherein a first parameter associated with the attribute information is decoded with a Logarithmic format plus a fixed integer, or at least one value associated with the attribute information is specified. This can provide at least one improvement for point cloud decoding such as geometry point cloud decoding, can work well for a wide range of point cloud decoding input, and/or can be used in many applications.

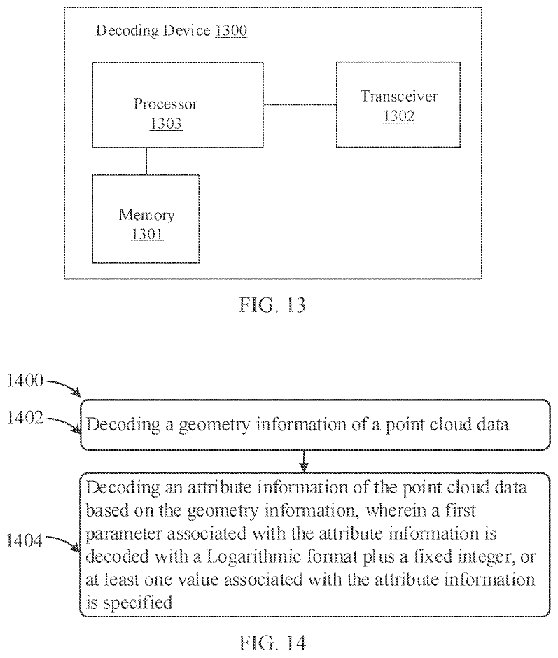

FIG. 13 illustrates an example of a decoding device 1300 according to an embodiment of the present disclosure. The decoding device 1300 is configured to implement some embodiments of the disclosure. Some embodiments of the disclosure may be implemented into the decoding device 1300 using any suitably configured hardware and/or software. The decoding device 1300 may include a memory 1301, a transceiver 1302, and a processor 1303 coupled to the memory 1301 and the transceiver 1302. The processor 1303 may be configured to implement proposed functions, procedures and/or methods described in this description. Layers of radio interface protocol may be implemented in the processor 1303. The memory 1301 is operatively coupled with the processor 1303 and stores a variety of information to operate the processor 1303. The transceiver 1302 is operatively coupled with the processor 1303, and the transceiver 1302 transmits and/or receives a radio signal. The processor 1303 may include application-specific integrated circuit (ASIC), other chipset, logic circuit and/or data processing device. The memory 1301 may include read-only memory (ROM), random access memory (RAM), flash memory, memory card, storage medium and/or other storage device. The transceiver 1302 may include baseband circuitry to process radio frequency signals. When the embodiments are implemented in software, the techniques described herein can be implemented with modules (e.g., procedures, functions, and so on) that perform the functions described herein. The modules can be stored in the memory 1301 and executed by the processor 1303. The memory 1301 can be implemented within the processor 1303 or external to the processor 1303 in which case those can be communicatively coupled to the processor 1303 via various means as is known in the art.

In some embodiments, the processor 1303 configured to decode a geometry information of a point cloud data and decode an attribute information of the point cloud data based on the geometry information, wherein a first parameter associated with the attribute information is decoded with a Logarithmic format plus a fixed integer, or at least one value associated with the attribute information is specified. This can provide at least one improvement for point cloud decoding such as geometry point cloud decoding, can work well for a wide range of point cloud decoding input, and/or can be used in many applications.

FIG. 14 is an example of a method 1400 of decoding point cloud data according to an embodiment of the present disclosure. The method 1400 of decoding point cloud data is configured to implement some embodiments of the disclosure. Some embodiments of the disclosure may be implemented into the method 1400 of decoding point cloud data using any suitably configured hardware and/or software. In some embodiments, the method 1400 of decoding point cloud data includes: an operation 1402, decoding a geometry information of a point cloud data, and an operation 1404, decoding an attribute information of the point cloud data based on the geometry information, wherein a first parameter associated with the attribute information is encoded with a Logarithmic format plus a fixed integer, or at least one value associated with the attribute information is specified. This can provide at least one improvement for point cloud decoding such as geometry point cloud decoding, can work well for a wide range of point cloud decoding input, and/or can be used in many applications.

In some embodiments, the first parameter includes maxNumofCoeff used to control a maximum buffer size to hold a number of transform coefficients. In some embodiments, log 2 maxNumofCoeffMinusX is decoded in a bitstream with a ue(v) format, where X is an integer number, and the ue(v) forma is 0-order exponential Golomb (EG) decoding. In some embodiments, X is equal to 8, the log 2maxNumofCoeffMinus8 is decoded, and the log 2maxNumofCoeffMinus8 is an unsigned integer number between 0 and 16 used to specify the maxNumofCoeff as the maximum buffer size to hold the number of transform coefficients. In some embodiments, maxNumofCoeff is calculated as follows: maxNumofCoeff=1<<(log 2maxNumofCoeffMinus8+8).

In some embodiments, the at least one value associated with the attribute information includes an allowed value of a second parameter and/or a third parameter associated with the attribute information, and the allowed value is not larger than a specified number. In some embodiments, the second parameter includes colorGolumbNum used to specify an order of EG for decoding a color attribute. In some embodiments, the third parameter includes RefGolombNum used to specify an order of EG for decoding a reflectance attribute. In some embodiments, the specified number is equal to 8.

In some embodiments, the at least one value associated with the attribute information includes a value of a zero-run-length, and the value of the zero-run-length is smaller than a predefined number. In some embodiments, if an order of EG used for decoding the attribute information is smaller than a predefined value, a first bin is decoded to indicate if the value of the zero-run-length is zero or not. In some embodiments, if the value of the zero-run-length is not zero, a second bin is decoded to indicate if the value of the zero-run-length is one or not. In some embodiments, if the value of the zero-run-length is not one, a third bin is decoded to indicate if the value of the zero-run-length is two or not. In some embodiments, if the value of the zero-run-length is not two, a parity flag is decoded to indicate if the value of the zero-run-length is an odd or even number.

In some embodiments, a remainder representing the value of (zero-run-length−2)/2 is decoded. In some embodiments, the remainder is decoded with a specified order EG or unary decode. In some embodiments, the specified order EG may be a 2nd order EG. In some embodiments, if a maximum number of bins is N, a maximum value for the 2nd-order EG decode is 1<<((N−1)>>2+2)−4, where N is an integer number. In some embodiments, if N is equal to 32, the maximum value for the remainder is 1<<((32−1)>>2+2)−4, which is equal to 131068. In some embodiments, the value of the zero-run-length is decoded with a parity value, a maximum value of the zero-run-length is 262138, which is 131068*2+2. In some embodiments, an allowed maximum value of the zero-run-length is set as a value smaller than 262138. In some embodiments, the allowed maximum value of the zero-run-length is set as a fixed number or decoded in a bitstream. In some embodiments, the allowed maximum value of the zero-run-length is set as 131072.

Commercial interests for some embodiments are as follows. 1. Providing at least one improvement for point cloud coding (encoding and/or decoding) such as geometry point cloud coding. 2. Working well for a wide range of point cloud coding input. 3. Some embodiments of the present disclosure can be used in many applications. 4. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future G-PCC coding standards, especially for audio video coding standard (AVS) GPCC (GPCC refers to G-PCC). Compatible products follow at least one proposed solution, method, system, and apparatus of some embodiments of the present disclosure. The proposed solution, method, system, and apparatus of some embodiments of the present disclosure are widely used in the G-PCC related products.

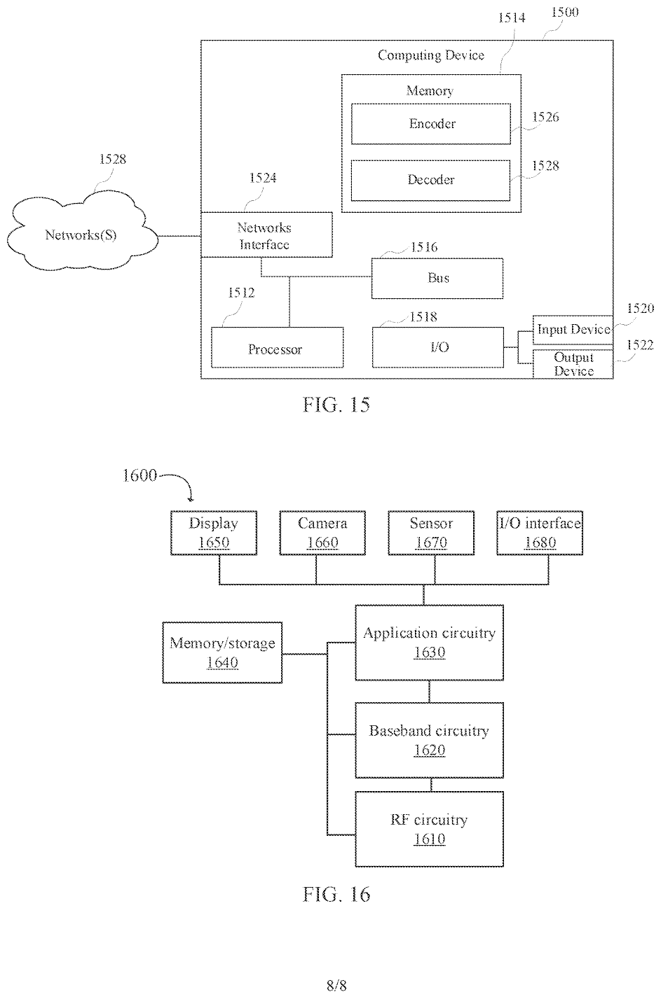

FIG. 15 is an example of a computing device 1500 according to an embodiment of the present disclosure. Any suitable computing device can be used for performing the operations described herein. For example, FIG. 15 illustrates an example of the computing device 1500 that can implement the G-PCC system 100 of FIG. 1, the G-PCC encoder 200 of FIG. 2, the G-PCC decoder 300 of FIG. 3, the point cloud coder 600 of FIG. 6, the coding device 700 of FIG. 7, the method 800 of coding point cloud data of FIG. 8, the point cloud encoder 900 of FIG. 9, the encoding device 1000 of FIG. 10, the method 1100 of encoding point cloud data of FIG. 11, the point cloud decoder 1200 of FIG. 12, the decoding device 1300 of FIG. 13, and/or the method 1400 of decoding point cloud data of FIG. 14 using any suitably configured hardware and/or software. In some embodiments, the computing device 1500 can include a processor 1512 that is communicatively coupled to a memory 1514 and that executes computer-executable program code and/or accesses information stored in the memory 1514. The processor 1512 may include a microprocessor, an application-specific integrated circuit (“ASIC”), a state machine, or other processing device. The processor 1512 can include any of a number of processing devices, including one. Such a processor can include or may be in communication with a computer-readable medium storing instructions that, when executed by the processor 1512, cause the processor to perform the operations described herein.

The memory 1514 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1500 can also include a bus 1516. The bus 1516 can communicatively couple one or more components of the computing device 1500. The computing device 1500 can also include a number of external or internal devices such as input or output devices. For example, the computing device 1500 is illustrated with an input/output (“I/O”) interface 1518 that can receive input from one or more input devices 1520 or provide output to one or more output devices 1522. The one or more input devices 1520 and one or more output devices 1522 can be communicatively coupled to the I/O interface 1518. The communicative coupling can be implemented via any suitable manner (e.g., a connection via a printed circuit board, connection via a cable, communication via wireless transmissions, etc.). Non-limiting examples of input devices 1520 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1522 include a liquid crystal display (LCD) screen, an external monitor, a speaker, or any other device that can be used to display or otherwise present outputs generated by a computing device.

The computing device 1500 can execute program code that configures the processor 1512 to perform one or more of the operations described above with respect to FIGS. 1-14. The program code can include an encoder 1526 and/or a video decoder 1528. The encoder 1526 may be the G-PCC system 100 of FIG. 1, the G-PCC encoder 200 of FIG. 2, the point cloud coder 600 of FIG. 6, the coding device 700 of FIG. 7, the point cloud encoder 900 of FIG. 9, or the encoding device 1000 of FIG. 10. The video decoder 1528 may be the G-PCC system 100 of FIG. 1, the G-PCC decoder 300 of FIG. 3, the point cloud coder 600 of FIG. 6, the coding device 700 of FIG. 7, the point cloud decoder 1200 of FIG. 12, or the decoding device 1300 of FIG. 13. The program code may be resident in the memory 1514 or any suitable computer-readable medium and may be executed by the processor 1512 or any other suitable processor.

The computing device 1500 can also include at least one network interface device 1524. The network interface device 1524 can include any device or group of devices suitable for establishing a wired or wireless data connection to one or more data networks 1528. Non limiting examples of the network interface device 1524 include an Ethernet network adapter, a modem, and/or the like. The computing device 1500 can transmit messages as electronic or optical signals via the network interface device 1524.

FIG. 16 is a block diagram of an example of a communication system 1600 according to an embodiment of the present disclosure. Embodiments described herein may be implemented into the communication system 1600 using any suitably configured hardware and/or software. FIG. 16 illustrates the communication system 1600 including a radio frequency (RF) circuitry 1610, a baseband circuitry 1620, an application circuitry 1630, a memory/storage 1640, a display 1650, a camera 1660, a sensor 1670, and an input/output (I/O) interface 1680, coupled with each other at least as illustrated.

The application circuitry 1630 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1600 can execute program code that configures the application circuitry 1630 to perform one or more of the operations described above with respect to FIGS. 1-14. The program code may be resident in the application circuitry 1630 or any suitable computer-readable medium and may be executed by the application circuitry 1630 or any other suitable processor.

The baseband circuitry 1620 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1620 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1610 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1610 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the G-PCC system 100 of FIG. 1, the G-PCC encoder 200 of FIG. 2, the G-PCC decoder 300 of FIG. 3, the point cloud coder 600 of FIG. 6, the coding device 700 of FIG. 7, the point cloud encoder 900 of FIG. 9, the encoding device 1000 of FIG. 10, the point cloud decoder 1200 of FIG. 12, or the decoding device 1300 of FIG. 13 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1640 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1680 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1670 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1650 may include a display, such as a liquid crystal display and a touch screen display. In various embodiments, the communication system 1600 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1-12. (canceled)

13. A method of encoding point cloud data, comprising:
encoding a geometry information of a point cloud data; and
encoding an attribute information of the point cloud data based on the geometry information, wherein a first parameter associated with the attribute information is encoded with a Logarithmic format minus a fixed integer, or at least one value associated with the attribute information is specified.

14. The method of encoding point cloud data of claim 13, wherein the first parameter comprises maxNumofCoeff used to control a maximum buffer size to hold a number of transform coefficients.

15. The method of encoding point cloud data of claim 14, wherein log 2 maxNumofCoeffMinusX is encoded in a bitstream with a ue(v) format, where X is an integer number, and the ue(v) forma is 0-order exponential Golomb (EG) encoding.

16. The method of encoding point cloud data of claim 15, wherein X is equal to 8, the log 2maxNumofCoeffMinus8 is encoded, and the log 2maxNumofCoeffMinus8 is an unsigned integer number between 0 and 16 used to specify the maxNumofCoeff as the maximum buffer size to hold the number of transform coefficients.

17. The method of encoding point cloud data of claim 16, wherein the maxNumofCoeff is calculated as follows: maxNumofCoeff=1<<(log 2maxNumofCoeffMinus8+8).

18. The method of encoding point cloud data of claim 13, wherein the at least one value associated with the attribute information comprises an allowed value of a second parameter and/or a third parameter associated with the attribute information, and the allowed value is not larger than a specified number.

19. The method of encoding point cloud data of claim 18, wherein the second parameter comprises colorGolumbNum used to specify an order of EG for encoding a color attribute.

20-24. (canceled)

25. A method of decoding point cloud data, comprising:
decoding a geometry information of a point cloud data; and
decoding an attribute information of the point cloud data based on the geometry information, wherein a first parameter associated with the attribute information is decoded with a Logarithmic format plus a fixed integer, or at least one value associated with the attribute information is specified.

26. The method of decoding point cloud data of claim 25, wherein the first parameter comprises maxNumofCoeff used to control a maximum buffer size to hold a number of transform coefficients.

27. The method of decoding point cloud data of claim 26, wherein log 2 maxNumofCoeffMinusX is decoded in a bitstream with a ue(v) format, where X is an integer number, and the ue(v) forma is 0-order exponential Golomb (EG) decoding.

28. The method of decoding point cloud data of claim 27, wherein X is equal to 8, the log 2maxNumofCoeffMinus8 is decoded, and the log 2maxNumofCoeffMinus8 is an unsigned integer number between 0 and 16 used to specify the maxNumofCoeff as the maximum buffer size to hold the number of transform coefficients.

29. The method of decoding point cloud data of claim 28, wherein the maxNumofCoeff is calculated as follows: maxNumofCoeff=1<<(log 2maxNumofCoeffMinus8+8).

30. The method of decoding point cloud data of claim 25, wherein the at least one value associated with the attribute information comprises an allowed value of a second parameter and/or a third parameter associated with the attribute information, and the allowed value is not larger than a specified number.

31. The method of decoding point cloud data of claim 30, wherein the second parameter comprises colorGolumbNum used to specify an order of EG for decoding a color attribute.

32. The method of decoding point cloud data of claim 30, wherein the third parameter comprises RefGolombNum used to specify an order of EG for decoding a reflectance attribute.

33. The method of decoding point cloud data of claim 30, wherein the specified number is equal to 8.

34. The method of decoding point cloud data of claim 25, wherein the at least one value associated with the attribute information comprises a value of a zero-run-length, and the value of the zero-run-length is smaller than a predefined number.

35. The method of decoding point cloud data of claim 34, wherein an allowed maximum value of the zero-run-length is set as a fixed number or decoded in a bitstream.

36. The method of decoding point cloud data of claim 35, wherein the allowed maximum value of the zero-run-length is set as 131072.

37-60. (canceled)

61. A point cloud decoder, comprising:
a decoder configured to:
decode a geometry information of a point cloud data; and
decode an attribute information of the point cloud data based on the geometry information, wherein a first parameter associated with the attribute information is decoded with a Logarithmic format plus a fixed integer, or at least one value associated with the attribute information is specified.

62-80. (canceled)
